(19) United States
(12) Patent Application Publication
(10) Pub. No.: US 2006/0078832 A1
(43) Pub. Date: Apr. 13, 2006

(54) Compositions for multi-color, light activated imaging

(76) Inventors: Makarand P. Gore, Corvallis, OR (US); Jayprakash Bhatt, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/960,658

(22) Filed: Oct. 7, 2004

(51) Int. Cl. G03C 1/73; G03C 1/725

(52) U.S. Cl. 430/332; 430/333; 430/338

(57) ABSTRACT

This invention relates to a direct, multi-color imaging composition, comprising a radiation absorber (antenna), a color former mixture of at least two color formers, and one or more activators, wherein one of the color formers reacts at a first elevated temperature to create a first color and another of the color formers reacts at a second elevated temperature to create a second color that is distinct from the first color.

### BACKGROUND OF THE INVENTION

1. Field of the Invention

This invention relates to a direct, multi-color imaging composition, comprising a radiation absorber (antenna), a color former mixture of at least two color formers, and at least one activator, wherein one of the color formers reacts at a first elevated temperature to create a first color and another of the color formers reacts at a second elevated temperature to create a second color that is distinct from the first color.

2. Description of the Related Art

Compositions which produce a color change upon exposure to energy in the form of light or heat are of great interest in producing images on a variety of substrates and surfaces. For a non-limiting example, optical disks represent a significant percentage of the market for data storage of software as well as of photographic, video, and/or audio data. Typically, optical disks have data patterns embedded thereon that can be read from and/or written to one side of the disk, and a graphic display or label printed on the other side of the disk. The data readable side, or data side, of the disk contains a spiral track of variably spaced depressions, called pits, separated by un-depressed surface areas, called lands. A low-powered laser is focused on to the spiral track. The height difference between pits and lands creates a phase shift in the reflected beam that may be measured and translated into usable data. Various optical disk formats include, but are not limited to, CD, CD-ROM, CD-R, CD-RW, DVD, DVD-R, and DVD-RW.

In order to identify the contents of the optical disk, printed patterns or graphic display information can be printed on the non-data side of disk. The patterns or graphic displays can be both decorative and provide pertinent information about the data content of the disk. Labeling of the optical disk has in the past been routinely accomplished through screen printing methods. While these methods can provide a variety of label content, they tend to be cost ineffective for production runs of less than 400 disks because of the fixed cost of the unique materials and set up are shared by all of the disks in each run. Also, the preparation of the stencil is an elaborate, time-consuming and expensive process. Consequently, a more advantageous system, then, would be provided if the use of the cost ineffective screen printing technique can be avoided.

It is also known, in the optical disk labeling art, to employ materials that produce color change upon stimulation with energy such as light or heat. For example, such materials may be found in thermal printing papers and instant imaging films. Generally, the materials and compositions known so far may require a multi-film structure and further processing to produce an image. In the case of thermal printing media, high energy input of greater than 1 J/cm² is needed to achieve good images. Also, the materials and compositions produce only one color image. In many situations, it may be desirable to produce a visible mark more efficiently using either a less intense, less powerful and/or shorter energy application that contains more than one color image. Therefore, there is a need for fast working coatings that produce more than one color change upon stimulation with energy.

Recently, color forming compositions have been developed which can be developed using energy sources such as lasers in order to form an image with improved marking speeds and reduced heat flux requirements. However, there is a need for compositions with desirable attributes such as even faster developing speeds. Particularly, there is a need for increased flexibility for color palette, and a variety in color forming processes. For these and other reasons, the need still exists for color forming compositions which allow cost effective production of more than one colored images.

It is apparent from the above that there exists a need in the light directed imaging art for a fast working coating that is cost effective and is able to produce more than one color change upon stimulation with energy. It is a purpose of this invention to fulfill this and other needs in the art in a manner more apparent to the skilled artisan once given the following disclosure.

### SUMMARY OF THE INVENTION

Generally speaking, an embodiment of this invention fulfills these needs by providing a direct, multi-color imaging composition, comprising an antenna, a color former mixture of at least two color formers, and at least one activator, wherein one of the color formers reacts at a first elevated temperature to create a first color and another of the color formers reacts at a second elevated temperature to create a second color that is distinct from the first color.

In certain preferred embodiments, the antenna refers generally to any radiation absorbing compound that readily absorbs the desired specific wavelength of the marking radiation. Also, the color former is a leuco dye that is a dye in a form which is, prior to development, substantially colorless or white, and which changes color(s) due to changes induced upon exposure to the imaging radiation. Finally, activator refers to a composition that is interactive or reactive with leuco dyes upon introduction of the marking radiation.

The preferred multi-color, light activated imaging composition, according to various embodiments of the present invention, offers the following advantages: excellent color forming characteristics, good durability, and excellent economy. In fact, in many of the preferred embodiments, these factors of color forming characteristics and economy are optimized to an extent that is considerably higher than heretofore achieved in prior, known imaging compositions.

The above and other features of the present invention, which will become more apparent as the description proceeds, are best understood by considering the following detailed description in conjunction with the accompanying drawings, wherein like characters represent like parts throughout the several views and in which:

### BRIEF DESCRIPTION OF THE DRAWINGS

FIG. 1 is a schematic illustration of a system for labeling a substrate, according to one embodiment of the present invention; and

FIG. 2 is a cross-sectional view of a portion of an optical disk, according to another embodiment of the present invention.

### DETAILED DESCRIPTION OF THE INVENTION

In describing and claiming the present invention, the following terminology will be used.

As used herein, media is meant to encompass any coatable surface, composed of wood, plastic, clay, paper, polymers, metals etc. One example is audio, video, multimedia, and/or software disks that are machine readable in a CD and/or DVD drive, or the like. Examples of optical disk formats include writable, recordable, and rewritable disks.

As used herein, “graphic display” can include any visible character or image found on a media or any surface used for viewing and conveying information. For example, the graphic display is found prominently on one side of the optical disk, but this is not always the case.

As used herein, “data” is typically used to include the non-graphic information contained on the optical disk that is digitally or otherwise embedded therein. Data can include audio information, video information, photographic information, software information, or the like.

As used herein, “leuco dye” refers to a dye in a form which is, prior to development, substantially colorless or white, and which changes color(s) upon exposure to changes induced by exposure to the energy. The color altering phenomenon is typically due to a chemical change, such as through oxidation, neutralization reaction, ring opening, ionization etc. resulting from energy exposure.

As used herein, “activator” refers to a composition that is interactive or reactive with leuco dyes upon introduction of heat.

As used herein, “developing” or “development” refers to the interaction or reaction of a leuco dye with another agent, such as an activator, to produce a visible composition having desired colors. The interaction is most often thermally initiated, but may also be physical in nature.

As used herein, “absorber” refers generally to an electromagnetic radiation sensitive agent that can generate heat upon exposure to a predetermined frequency of electromagnetic radiation. The predetermined frequency can be different from one absorber composition to the next. When admixed with or in thermal contact with a leuco dye and/or activator, an absorber can be present in sufficient quantity so as to produce heat sufficient to at least partially develop the leuco dye, in accordance with embodiments of the present invention. Typically, development of the leuco dye can result from interaction between the leuco dye and the activator composition.

As used herein, “antenna” refers generally to any radiation absorbing compound that readily absorbs the desired specific wavelength of the marking radiation.

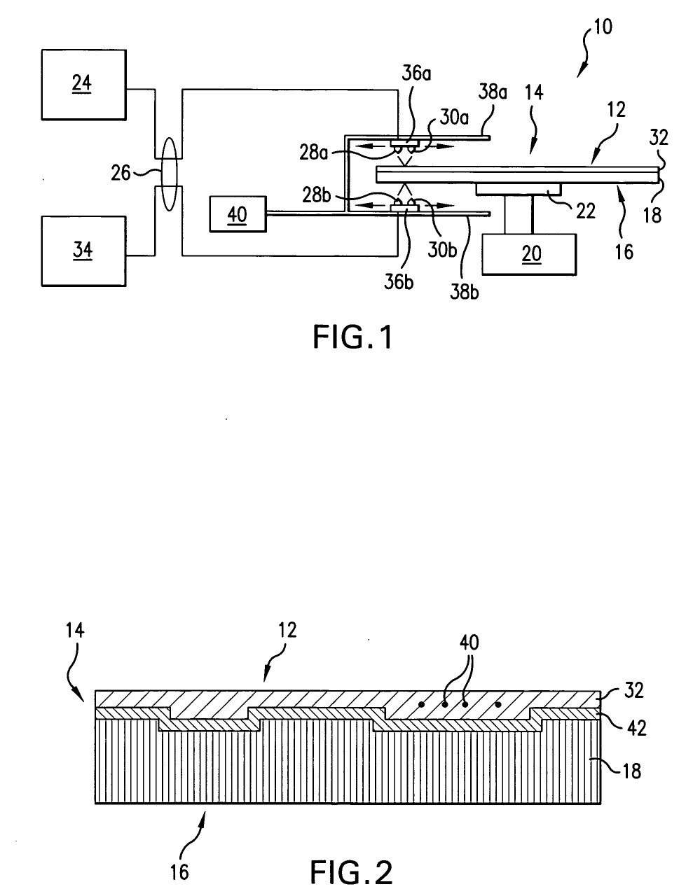

With reference first to FIG. 1, a system for labeling a substrate having a leuco dye thereon, indicated generally at 10, in accordance with the present invention, is shown. In this embodiment, the system can simultaneously write to the image side 12 of an optical disk 14 and collect and/or write data to the data side 16 of the optical disk. The optical disk substrate 18 is shown in a first orientation, with the image side 12 facing in an upward direction. A motor 20 and a support member 22 are present for spinning and supporting the optical disk 14.

In accordance with the present invention, an image is digitally stored on image data source 24. This image information can be generated using any number of commercially available image software programs. The image can then be rasterized or spiralized and delivered to a labeling electromagnetic radiation source via signal processor 26. This process generally involves digitizing image data to correspond to a spiral path that matches the path followed by the electromagnetic radiation source with respect to the image side 12 of the optical disk 14 while spinning.

In one embodiment, the labeling electromagnetic radiation source is an emitting device 28a and an optional label detecting device 30a facing the image side 12 of the spinning optical disk 14 having a leuco dye composition 32 thereon. Additionally, an optional second emitting device 28b and a second detecting device 30b face the data side 16 and are configured for simultaneous reading and/or writing operations. The data can be generated, used, and/or stored in data source 34. In one embodiment, data can be written by sending it to the second emitting device 28b via signal processor 26. Each set of emitters and detectors are positioned on a first sled 36a and a second sled 36b, respectively. Additionally, the first sled 36a and the second sled 36b follow a first track 38a and a second track 38b, respectively. In this embodiment, a single solenoid 40 is shown that acts to simultaneously cause both the first sled 36a and the second sled 36b to travel and collect information in unison. However, this is not required.

The present invention relates generally to labeling a substrate using a mixture of two or more fluoran leuco dyes, capable of color change under two differentiated energy input conditions. As illustrated in FIG. 2, media such as an optical disk, shown generally at 14, includes a substrate 18 having various coatings is shown. The substrate 18 is generally used for structural support and has a data side 16 and a label side 12. The substrate 18 can be made of any suitable material such as a polycarbonate for optical disks or other materials. A data layer 42 is generally formed by sputtering or other known processes and can contain any known materials capable of creating, maintaining, and/or mimicking pits and lands corresponding to specific data. Thus, though a single data layer is shown, it is understood that multiple layers can be used, such as for writable and/or rewritable formats. As such, materials for use in creating permanent (ROM), writable, or rewritable formats are well known to those skilled in the art. These materials include, but are not limited to, aluminum, cyanine, phthalocyanine, metallized azo dyes, and photosensitive compounds in a polymer binder in a dye layer. For example, rewritable optical disks typically include a quaternary phase-change alloy exhibiting different reflective properties in the amorphous and crystalline states. The data layer can also contain colorants which do not affect the data storage performance of the data layer. The above compositions are readable or writable as to the data side 16 of the optical disk 14.

The leuco dyes and activators of the present invention can be prepared and applied in a variety of ways to media. For example, as shown in FIG. 2, an electromagnetic, radiation sensitive, imaging composition 32 can be prepared containing the leuco dyes (or color former), an activator, and an electromagnetic radiation absorber. As the electromagnetic radiation sensitive composition of the embodiment provides not only a leuco dye and activator function, it is also used to protect the top surface of the disk. Various additional components, such as lubricants, surfactants, and materials imparting moisture resistance, can also be added to provide mechanical protection to the electromagnetic radiation sensitive composition.

Imaging composition 32 may comprise a matrix, an activator, a radiation absorbing compound such as a dye, and a color forming dye. The activator and the color forming dye, when mixed, may change color. Either of the activator and the color forming dye may be soluble in the matrix. The other component (activator or color forming dye) may be substantially insoluble in the matrix and may be suspended in the matrix as uniformly distributed particles 40. The imaging composition 32 may be applied to the substrate via any acceptable method, such as, by way of example only, rolling, spraying, or screen printing.

Energy may be directed image-wise to imaging composition 32. The form of energy may vary depending upon the equipment available, ambient conditions, and desired result. Examples of energy which may be used include IR radiation, UV radiation, x-rays, or visible light. The antenna may absorb the energy and heat the imaging composition 32. The heat may cause suspended particles 40 to reach a temperature sufficient to cause the inter-diffusion of the color forming species initially present in the particles (e.g., glass transition temperatures (T_{g}) or melting temperatures (Tₘ) of the particles 40 and matrix). The activator and dye may then react to form a color. The temperature of development of a specific color change can also depend on the melting point (Tₘ) of the leuco dye

Example 1 illustrates an exemplary embodiment of the present invention. Several modifications may be made that are within the scope of the present invention. For example, antenna may be any material which effectively absorbs the type of energy to be applied to the imaging medium to create a mark. By way of example only, the following compounds IR780 (Aldrich 42,531-1) (1), IR783 (Aldrich 54,329-2) (2), Syntec 9/1 (3), Syntec 9/3 (4) or metal complexes (such as dithiolane metal complexes (5) and indoaniline metal complexes (6)) may be suitable antennae. Preferably, the antenna is indocyanine green.

Generally, leuco dyes are substantially colorless and are in a lactone closed ring form. Although a wide range of compositions are suitable for use in the present invention, an electromagnetic radiation sensitive composition may contain less than about 5 to 40% by weight of leuco dye and activator, and is preferably about 10 to 20% by weight. These ranges are only exemplary and other weight ranges may be used depending on the desired image characteristics and other considerations. Activator to leuco dye weight ratios of between about 1:0.5 and 1:3 typically provide adequate results and a ratio of about 1:1 may also be used. Ideally, the leuco dye used in practice of this invention can be chosen from dyes described iin “Chemistry and Applications of Leuco Dyes”, Muthyala, R. Ed. Plenum Press NY, 1997, ISBN 0-306-45459-9. Preferably, the leuco dye is a fluron leuco dye. Many of these are available from Nagase Americas, NY; Noveon, Cincinnati, and Ciba Specialty Chemicals Corp. High Point N.C., under the name Pergascript®.

As stated above, interaction between a leuco dye and an activator can cause a chemical change in the leuco dye, thereby altering the color of the leuco dye from substantially white or colorless to another color. Generally, the chemical change in the leuco dye occurs upon application of a predetermined amount of heat. Activators suitable for use in the present invention can be chosen by those skilled in the art. Several non-limiting examples of suitable activators include phenols, carboxylic acids, lewis acids, oxalate complexes, succinate acid, zinc stearate, and combinations thereof. Preferably, the activator can be a phenol, such as Bis phenol A, sulfonyldiphenol, or TG-SA, available from Nagase America, NY.

As the predetermined amount of heat is provided by the electromagnetic radiation absorber, matching of the electromagnetic radiation frequency and intensity to the absorber used can be done to optimize the system. The absorber can be present in the electromagnetic sensitive leuco dye composition in an amount of typically between about 0.1 to 10% and about 0.5 to 1% by weight, although other weight ranges may be required depending on the molar absorptivity of the particular absorber. Examples of frequencies that can be selected include infrared, visible, ultraviolet, or combinations thereof, e.g 405 nm, 650 nm, 780 nm, 1084 nm.

Radiation Absrober/Antennae

A radiation antenna, which acts as an efficient energy absorber, can be included in the color forming composition as a component which can be used to optimize development of the color forming composition upon exposure to radiation at a predetermined exposure time and/or wavelength. The radiation antenna can act as an energy antenna, providing energy to surrounding areas upon interaction with an energy source. As a predetermined amount of energy can be provided by the radiation antenna, matching of the radiation wavelength and intensity to the particular antenna used can be carried out to optimize the system within a desired optimal range. Most common commercial applications can require optimization to a development wavelength of about 200 nm to about 900 nm, although wavelengths outside this range can be used by adjusting the radiation antenna and color forming composition accordingly.

Suitable radiation antenna can be selected from a number of radiation absorbers such as, but not limited to, aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures or derivatives thereof. Other suitable antennas can also be used in the present invention and are known to those skilled in the art and can be found in such references as “Infrared Absorbing Dyes”, Matsuoka, Masaru, ed., Plenum Press, New York, 1990 (ISBN 0-306-43478-4) and “Near-Infrared Dyes for High Technology Applications”, Daehne, Resch-Genger, Wolfbeis, Kluwer Academic Publishers (ISBN 0-7923-5101-0), both incorporated herein by reference.

Various radiation antennas can act as an antenna to absorb electromagnetic radiation of specific wavelengths and ranges. Generally, a radiation antenna which has a maximum light absorption at or in the vicinity of the desired development wavelength can be suitable for use in the present invention. For example, in one aspect of the present invention, the color forming composition can be optimized within a range for development using infrared radiation having a wavelength from about 720 nm to about 900 nm. Common CD-burning lasers have a wavelength of about 780 nm and can be adapted for forming images by selectively developing portions of the color forming composition. Radiation antennae which can be suitable for use in the infrared range can include, but are not limited to, polymethyl indoliums, metal complex IR dyes, indocyanine green, polymethine dyes such as pyrimidinetrione-cyclopentylidenes, guaiazulenyl dyes, croconium dyes, cyanine dyes, squarylium dyes, chalcogenopyryloarylidene dyes, metal thiolate complex dyes, bis(chalcogenopyrylo)polymethine dyes, oxyindolizine dyes, bis(aminoaryl)polymethine dyes, indolizine dyes, pyrylium dyes, quinoid dyes, quinone dyes, phthalocyanine dyes, naphthalocyanine dyes, azo dyes, hexafunctional polyester oligomers, heterocyclic compounds, and combinations thereof.

Several specific polymethyl indolium compounds are available from Aldrich Chemical Company and include 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate; 2-[2-[2-Chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium chloride; 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene)ethylidene]-2-(phenylthio)-1-cyclohexen-1-yl]ethenyl]-3,3-dimethyl-1-propylindolium perchlorate; and mixtures thereof. Alternatively, the radiation antenna can be an inorganic compound, e.g., ferric oxide, carbon black, selenium, or the like. Polymethine dyes or derivatives thereof such as a pyrimidinetrione-cyclopentylidene, squarylium dyes such as guaiazulenyl dyes, croconium dyes, or mixtures thereof can also be used in the present invention. Suitable pyrimidinetrione-cyclopentylidene infrared antennae include, for example, 2,4,6(1H,3H,5H)-pyrimidinetrione 5-[2,5-bis[(1,3-dihydro-1,1,3-dimethyl-2H-indol-2-ylidene)ethylidene]cyclopentylidene]-1,3-dimethyl-(9CI) (S0322 available from Few Chemicals, Germany)

In another aspect of the present invention, the radiation antenna can be selected for optimization of the color forming composition in a wavelength range from about 600 nm to about 720 nm, such as about 650 nm. Non-limiting examples of suitable radiation antennae for use in this range of wavelengths can include indocyanine dyes such as 3H-indolium, 2-[5-(1,3-dihydro-3,3-dimethyl-1-propyl-2H-indol-2-ylidene)-1,3-pentadienyl]-3,3-dimethyl-1-propyl-,iodide) (Dye 724 max 642 nm), 3H-indolium, 1-butyl-2-[5-(1-butyl-1,3-dihydro-3,3-dimethyl-2H-indol-2-ylidene)-1,3-pentadienyl]-3,3-dimethyl-,perchlorate (Dye 683 max 642 nm), and phenoxazine derivatives such as phenoxazin-5-ium, 3,7-bis(diethylamino)-,perchlorate (oxazine 1 max=645 nm). Phthalocyanine dyes having a max of about the desired development wavelength can also be used such as silicon 2,3-napthalocyanine bis(trihexylsilyloxide) and matrix soluble derivatives of 2,3-napthalocyanine (both commercially available from Aldrich Chemical); matrix soluble derivatives of silicon phthalocyanine (as described in Rodgers, A. J. et al., 107 J. Phys. Chem. A 3503-3514, May 8, 2003), and matrix soluble derivatives of benzophthalocyanines (as described in Aoudia, Mohamed, 119 J. Am. Chem. Soc. 6029-6039, Jul. 2, 1997); phthalocyanine compounds such as those described in U.S. Pat. Nos. 6,015,896 and 6,025,486, which are each incorporated herein by reference; and Cirrus 715 (a phthalocyanine dye available from Avecia, Manchester, England having a max=806 nm).

In yet another aspect of the present invention, laser light having blue and indigo wavelengths from about 300 nm to about 600 nm can be used to develop the color forming compositions. Therefore, the present invention can provide color forming compositions optimized within a range for use in devices that emit wavelengths within this range. Recently developed commercial lasers found in certain DVD and laser disk recording equipment provide for energy at a wavelength of about 405 nm. Thus, the compositions of the present invention using appropriate radiation antennae can be suited for use with components that are already available on the market or are readily modified to accomplish imaging. Radiation antennae which can be useful for optimization in the blue (405 nm) and indigo wavelengths can include, but are not limited to, aluminum quinoline complexes, porphyrins, porphins, and mixtures or derivatives thereof. Non-limiting specific examples of suitable radiation antenna can include 1-(2-chloro-5-sulfophenyl)-3-methyl-4-(4-sulfophenyl)azo-2-pyrazolin-5-one disodium salt (λ max=400 nm); ethyl 7-diethylaminocoumarin-3-carboxylate (λ max=418 nm); 3,3′-diethylthiacyanine ethylsulfate (λ max=424 nm); 3-allyl-5-(3-ethyl-4-methyl-2-thiazolinylidene) rhodanine (λ max=430 nm) (each available from Organica Feinchemie GmbH Wolfen), and mixtures thereof. Non-limiting specific examples of suitable aluminum quinoline complexes can include tris(8-hydroxyquinolinato)aluminum (CAS 2085-33-8) and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)-4,5-dihydro-naphtho[1,2-d]1,3-dithiole, all available from Syntec GmbH. Non-limiting examples of specific porphyrin and porphyrin derivatives can include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange CAS 2243-76-7, Merthyl Yellow (60-11-7), 4-phenylazoaniline (CAS 60-09-3), Alcian Yellow (CAS 61968-76-1), available from Aldrich chemical company, and mixtures thereof.

Developer/Stabilizer

In accordance with the present invention, the color forming compositions can further include a developer or a stabilizer. Without subscribing to a particular effect, the developer is capable of developing a color change in reaction with the color former. The stabilizer can be capable of stabilization of the color former in a developed state and/or act as an activator to facilitate development of the color former. In many cases, a component may perform both functions. Specifically, in some embodiments of the present invention, the Leuco dyes are no longer photochromic, e.g., at least partially due to the dispersion in a UV or polymer matrix and/or the accompanying radiation antenna. Suitable stabilizers can include any agent which is capable of facilitating development of the color former and/or preventing the color former from reverting to the closed, or undeveloped, form. Non-limiting examples of suitable stabilizers can include zinc salts such as zinc stearate, zinc hexanoate, zinc salicylate, zinc acetate, carboxylates such as calcium monobutylphthalate, phenolic compounds such as bisphenol-A, Sulfonyl Diphenol, TG-SA and zinc or calcium salts thereof. As a general guideline, the color forming compositions of the present invention can include from about 5 wt % to about 40 wt % developer/stabilizer. Preferably, 10 to 20% of the total composition consists of Developer/Stabilizer

Matrix

The color forming compositions of the present invention can typically include a polymer matrix which acts primarily as a binder. As mentioned above, the color former phase can be dispersed within the polymer matrix. Various polymer matrix materials can influence the development properties of the color forming composition such as development speed, light stability, and wavelengths which can be used to develop the composition. Acceptable polymer matrix materials can also include, by way of example, UV curable polymers such as acrylate derivatives, oligomers, and monomers, such as included as part of a photo package. A photo package can include a light absorbing species which initiates reactions for curing of a lacquer. Such light absorbing species can be sensitized for curing using UV or electron beam curing systems, such as, by way of example, benzophenone derivatives. Other examples of photoinitiators for free radical polymerization monomers and pre-polymers can include, but are not limited to, thioxanethone derivatives, anthraquinone derivatives, acetophenones, and benzoine ethers. Additional examples of matrix materials, prepared and coated as dispersions in water or solvents, solutions, solid melts include Polyvinyl alcohol, Polyvinyl Chloride, Polyvinyl Butyral, Cellulose esters and blends such as cellulose acetate butyrate, Polymers of styrene, butadiene, ethylene, poly carbonates, polymers of Vinyl carbonates such as CR39, available from PPG industries, Pittsburgh, and co-polymers of acrylic and allyl carbonate momoners such as BX-946, available form Hampford Research, Stratford, Conn. These components can be dissolved, dispersed, ground and deposited in these matrices, and the films can be formed using commonly known processes such as solvent or carrier evaporation, vacuum heat, drying and processing using light.

In particular embodiments of the invention, it can be desirable to choose a polymer matrix which is cured by a form of radiation that does not also develop the color former or otherwise decrease the stability of the color forming composition at the energy input and flux necessary to cure the coatings. Thus, the polymer matrix can be curable at a curing wavelength which is substantially different than the development wavelength.

Further, a suitable photo-initiator should also have light absorption band which is not obscured by the absorption band of the radiation antenna, otherwise the radiation antenna can interfere with photo-initiator activation and thus prevent cure of the coating. However, in practice, the absorption bands of the photo-initiator and radiation antennae can overlap. In such cases, a working system design is possible because the energy flux required for development of a color former is about ten times higher than needed for initiation of the cure. In yet another embodiment, the radiation antenna has a dual function; one of sensitization of cure for UV cure under cure conditions (relatively low energy flux), and provides for energy for marking during development. Polymer matrix materials based on cationic polymerization resins can include photo-initiators based on acyloin compounds, aromatic diazonium salts, aromatic halonium salts, aromatic sulfonium salts, phosphine oxide, amine-ketne class, and metallocene compounds. Many of these are available as Irgacure and Darocure materials from Ciba-Giegy, and included by reference. Additional components such as sensitizers, additional photo-initiators, or the like can also be used, in accordance with principles known to those skilled in the art.

Additionally, binders can be included as part of the polymer matrix. Suitable binders can include, but are not limited to, polymeric materials such as polyacrylate from monomers and oligomers, polyvinyl alcohols, polyvinyl pyrrolidines, polyethylenes, polyphenols or polyphenolic esters, polyurethanes, acrylic polymers, and mixtures thereof. For example, the following binders can be used in the color forming composition of the present invention: cellulose acetate butyrate, ethyl acetate butyrate, polymethyl methacrylate, polyvinyl butyral, and mixtures thereof.

These compositions are chosen such that the color formers react stepwise with the activator at specific temperature and energy flux. In accordance with another aspect of the present invention, the leuco dyes can be developed under conditions of exposure to specific types of electromagnetic radiation, including electromagnetic radiation produced using a laser. Lasers are available which produce radiation in visible, infrared, and ultraviolet frequencies. For example, lasers having frequencies anywhere from about 200 nm to about 3000 nm are readily commercially available.

The conditions under which the leuco dyes of the present invention are developed can be varied. For example, one can vary the electromagnetic radiation frequency, heat flux, and exposure time. Variables such as spot size and laser power will also affect any particular system design and can be chosen based on the desired results. With these variables, the electromagnetic radiation source can direct electromagnetic radiation to the electromagnetic radiation sensitive composition, in accordance with the image data source and information received from the signal processor. Further, the leuco dye and/or activator concentrations and proximity to one another can also be varied.

The leuco dyes of the present invention can be developed to image-wise produce desired color or colors using lasers having from 15 to 100 mW power usage, although lasers having a power outside this range can also be used. The spot size can be determined by considering the electromagnetic radiation source, and can range from about 1μ to about 200μ, in the largest dimension, though smaller or larger sizes can also be used. In one embodiment, a radiation spot size of between about 101 and about 100μ can also be utilized. In a further aspect, spot sizes of 20μ by 50.μ can provide a good balance between resolution and developing speed.

Heat flux is a variable that can be altered as well, and can be from about 0.1 to 10 J/cm² in one embodiment, and from about 0.3 to 0.5 J/cm² in a second embodiment. Energy flux in these ranges allow for development of leuco dyes in less than about 200 microsec per dot in some embodiments, less than about 100 microsec per dot in other embodiments, and 20 microsec or less per dot in still other embodiments. Preferably, the laser is operated at a difference of energy flux of 0.2 joules/cm² to create the first elevated temperature and at a difference in energy flux of 0.5 to 5 joules/cm² to create the second elevated temperature.

### EXAMPLE 1

This invention describes methods and specific compositions of coatings amenable for image-wise producing more than one color image using light in a single coating. These contain at least four essential components with specific temperature dependent reactions. For differential color development, the properties are critical to the success of color production during coatings preparation, and to the ability to form specific color upon delivery of energy are—melting point, solubility, reactivity, melting point of an alloy, or developer. In this composition, one of the color-former (for example a fluoran Leuco dye) reacts at a specific elevated temperature (80-120° C.) and energy input of 0.1 to 0.3 joules/cm², and another color former reacts at another higher temperature (160-200° C.) and energy flux (0.3 to 1 joules/cm²). An IR dye compound (antenna), and the activator (for example a phenolic compound) are included in matrix or a binder such as acrylate derivatives with a photo package, or polyvinylbutryl and cellulose acetate resins. The temperature is controlled by residence time in one method. In another, the laser power can be adjusted to desired levels. The energy input and temperature is inversely proportional to speed at a given power setting.

The IR absorbing dye (antenna) is an essential component. It is preferably introduced into the matrix as a solid state amorphous solution in the activator for uniform distribution. Introduction of the antenna dye into the coating pre-polymers in the form of solid state solution in activator is very important, because it enables uniform distribution of antenna in the coating. This is not always the case when IR antenna is dissolved in coating pre-polymer.

In the process of marking, the laser energy is:
a) Absorbed by the antenna uniformly distributed in the matrix. It results in the heating of the coating;
b) Without subscribing to a particular theory, differentially activates one of the color formers in the coating thereby leading to phase change (melting or glass transition)

Melting of the insoluble phase enables its inter-diffusion and interaction with the activator dissolved in the matrix and, hence, formation of the colored complex. The activator may diffuse into the dye melt, and vice versa.

The feasibility and method of practice of invention can be demonstrated by applying a coat of IR absorber to a commercially available media containing materials that can be differentially activated. A commercial thermal paper available form Appelton, Wi, USA, was modified for light activation using IR absorber solutions. For example, a dye chosen from indocyanine green available from Aldrich, or IR 715 available from Avecia. This media was conventionally mounted on optical discs for marking with a 35 mW laser. The speed of marking was varied to adjust the laser residence time, and thus the energy input. Indeed, the marking experiments showed that one color, red, can be developed at lower energy settings (fast speed) of 0.5 m/sec, and other (black) color can be developed at slower <0.3 m/sec settings. It is possible that both of the dyes could develop at higher energy settings.

Once given the above disclosure, many other features, modifications or improvements will become apparent to the skilled artisan. Such features, modifications or improvements are, therefore, considered to be a part of this invention, the scope of which is to be determined by the following claims.

1. A direct, multicolor imaging composition, comprising:
an electromagnetic radiation absorber combined with a color former mixture of at least two color formers; and
at least one activator, wherein one of the color formers reacts at a first light exposure to create a first color and another of the color formers reacts at a second light exposure to create a second color that is distinct from the first color.

2. The composition, as in claim 1, wherein the antenna is further comprised of:
a radiation absorbing compound that readily absorbs the desired specific wavelength of the marking radiation.

3. The composition, as in claim 1, wherein the activator is further comprised of:
a composition that is interactive or reactive with the color former upon introduction of light.

4. The composition, as in claim 1, wherein the color formers are further comprised of:
leuco dyes.

5. The composition, as in claim 4, wherein the leuco dyes are further comprised of:
dyes in a form which is, prior to development, substantially colorless or white, and which changes color(s) upon exposure to light.

6. The composition, as in claim 4, wherein the leuco dyes are further comprised of:
flouran leuco dyes.

7. The composition, as in claim 2, wherein the antenna is further comprised of at least one of the compounds chosen from the group consisting of:
aluminum quinoline complexes, porphyrins, porphins, indocyanine dyes, phenoxazine derivatives, phthalocyanine dyes, polymethyl Indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures or derivatives thereof.

8. The composition, as in claim 2, wherein the antenna is further comprised of at least one of the compounds chosen from the group consisting of:
polymethyl indoliums, metal complex IR dyes, indocyanine green, polymethine dyes, guaiazulenyl dyes, croconium dyes, cyanine dyes, squarylium dyes, chalcogenopyryloarylidene dyes, metal thiolate complex dyes, bis(chalcogenopyrylo)polymethine dyes, oxyindolizine dyes, bis(aminoaryl)polymethine dyes, indolizine dyes, pyrylium dyes, quinoid dyes, quinone dyes, phthalocyanine dyes, naphthalocyanine dyes, azo dyes, hexafunctional polyester oligomers, heterocyclic compounds, and combinations thereof.

9. The composition, as in claim 8, wherein the polymethyl indollum compound is further comprised of at least one of the compounds chosen from the group consisting of:
2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate; 2-[2-[2-Chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium chloride; 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene)ethylidene]-2-(phenylthio)-1-cyclohexen-1-yl]ethenyl]-3,3-dimethyl-1-propylindolium perchlorate; and mixtures thereof.

10. The composition, as in claim 8, wherein the polymethine dye compound is further comprised of:
pyrimidinetrione-cyclopentylidenes.

11. The composition, as in claim 8, wherein the squarylium dye is further comprised of:
a guaiazulenyl dye.

12. The composition, as in claim 2, wherein the antenna is further comprised of at least one of the compounds chosen from the group consisting of:
indocyanine dyes such as 3H-indolium,2-[5-(1,3-dihydro-3,3-dimethyl-1-propyl-2H-indol-2-ylidene)-1,3-pentadienyl]-3,3-dimethyl-1-propyl-,iodide) (Dye 724 λmax 642 nm), 3H-indolium, 1-butyl-2-[5-(1-butyl-1,3-dihydro-3,3-dimethyl-2H-indol-2-ylidene)-1,3-pentadienyl]-3,3-dimethyl-,perchlorate (Dye 683 λmax 642 nm), and phenoxazine derivatives such as phenoxazin-5-ium,3,7-bis(diethylamino)-,perchlorate (oxazine 1 λmax=645 nm) and mixtures thereof.

13. The composition, as in claim 2, wherein the antenna is further comprised of at least one of the compounds chosen from the group consisting of:
1-(2-chloro-5-sulfophenyl)-3-methyl-4-(4-sulfophenyl)azo-2-pyrazolin-5-one disodium salt (□max=400 nm); ethyl 7-diethylaminocoumarin-3-carboxylate (□max=418 nm); 3,3′-diethylthiacyanine ethylsulfate (□max=424 nm); 3-allyl-5-(3-ethyl-4-methyl-2-thlazolinylidene) rhodanine (□max=430 nm) and mixtures thereof.

14. The composition, as in claim 7, wherein the aluminum quinoline complexes are further comprised of at least one of the group of:
tris(8-hydroxyquinolinato)aluminum (CAS 2085-33-8) and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)-4,5-dihydro-naphtho[1,2-d]1,3-dithiole and mixtures thereof.

15. The composition, as in claim 7, wherein the antenna is further comprised of:
indocyanine green.

16. The composition, as in claim 3, wherein the activator is further comprised of at least one of the compounds chosen from the group consisting of:
zinc salts, carboxylates, phenolic compounds, or calcium salts, and combinations thereof.

17. The composition, as in claim 16, wherein the zinc salts are further comprised of:
zinc stearate, zinc hexanoate, zinc salicylate, or zinc acetate and mixtures thereof.

18. The composition, as in claim 16, wherein the phenolic compounds are further comprised of:
bisphenol-A.

19. The composition, as in claim 16, wherein the phenolic compounds are further comprised of:
TG-SA.

20. The composition, as in claim 16, wherein the activator is further comprised of:
sulfonyl diphenol.

21. The composition, as in claim 1, wherein the activator comprises by weight 5 to 40 weight % solid particles.

22. The composition, as in claim 21, wherein the activator comprises by weight 10 to 20 weight % solid particles.

23. The composition, as in claim 1, wherein the compound is further comprised of:
a matrix in which the color formers are dispersed.

24. The composition, as in claim 23, wherein the matrix is further comprised of:
UV-curable polymers.

25. The composition, as in claim 24, wherein the polymers are further comprised of at least one of the compounds chosen from the group consisting of:
acrylate derivatives, oligomers, monomers, and combinations thereof.

26. The composition, as in claim 25, wherein the polymers are further comprised of at least one of the compounds chosen from the group consisting of:
polyvinyl alcohol, polyvinyl chloride, polyvinyl butyral, cellulose esters and blends such as cellulose acetate butyrate, polymers of styrene, butadiene, ethylene, poly carbonates, polymers of vinyl carbonates, copolymers of acrylic and allyl carbonate momoners, and combinations thereof.

27. The composition, as in claim 25, wherein the polymers are further comprised of at least one of the compounds chosen from the group consisting of;
acyloin compounds, aromatic diazonium salts, aromatic halonium salts, aromatic sulfonium salts, phosphine oxide, amine-ketne class, metallocene compounds, and combinations thereof.

28. The composition, as claim 23, wherein the matrix is further comprised of:
binders.

29. The composition, as claim 28, wherein the binders are comprised of at least one of the compounds chosen from the group consisting of:
polyacrylates, polyvinyl alcohols, polyvinyl pyrrolidines, polyethylenes, polyphenols or polyphenolic esters, polyurethanes, acrylic polymers, and mixtures thereof.

30. The composition, as claim 29, wherein the binders are comprised of at least one of the compounds chosen from the group consisting of:
cellulose acetate butyrate, ethyl acetate butyrate, polymethyl methacrylate, polyvinyl butyral, and mixtures thereof.

31. A method for preparing a direct imaging compound, the method comprising:
providing an antenna combined with a color former mixture of at least two color formers; and providing at least one activator, wherein one of the color formers reacts at a first light exposure to create a first color and another of the color formers also reacts at a second light exposure to create a second color that is distinct from the first color.

32. The method, as in claim 31, wherein the first light exposure step is further comprised of:
employing a difference in energy flux of 0.2 joules/cm².

33. The method, as in claim 31, wherein the second light exposure step is further comprised of:
employing a difference in energy flux of 0.5 to 5 joules/cm².

34. The method, as in claim 31, wherein the method is further comprised of:
employing light exposure through the use of a laser.

35. The method, as in claim 34, wherein the laser is operated at a power range of 15 to 100 mW.

36. The method, as in claim 34, wherein the laser produces a spot size range of 10μ to 100μ.

37. The method, as in claim 36, wherein the laser produces a spot size of 20μ to 50μ.

38. An image recording medium, comprising:
an antenna combined with a color former mixture of at least two color formers; and
at least one activator, wherein one of the color formers reacts at a first light exposure to create a first color and another of the color formers reacts at a second light exposure to create a second color that is distinct from the first color.

39. The medium, as in claim 38, wherein the antenna is further comprised of:
a radiation absorbing compound that readily absorbs the desired specific wavelength of the marking radiation.

40. The medium, as in claim 38, wherein the activator is further comprised of:
a composition that is interactive or reactive with the color former upon introduction of light.

41. The medium, as in claim 38, wherein the color formers are further comprised of:
leuco dyes.

42. The medium, as in claim 41, wherein the leuco dyes are further comprised of:
dyes in a form which is, prior to development, substantially colorless or white, and which changes color(s) upon exposure to heat.

43. The medium, as In claim 41, wherein the leuco dyes are further comprised of:
flouran leuco dyes.

44. The medium, as in claim 39, wherein the antenna is further comprised of at least one of the compounds chosen from the group consisting of:
aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogenopyryloarylidene dyes, indolizine dyes, pyrylium dyes, quinoid dyes, quinone dyes, azo dyes, and mixtures or derivatives thereof.

45. The medium, as in claim 39, wherein the antenna is further comprised of at least one of the compounds chosen from the group consisting of:
polymethyl indoliums, metal complex IR dyes, indocyanine green, polymethine dyes, guaiazulenyl dyes, croconium dyes, cyanine dyes, squarylium dyes, chalcogenopyryloarylidene dyes, metal thiolate complex dyes, bis(chalcogenopyrylo)polymethine dyes, oxyindolizine dyes, bis(aminoaryl)polymethine dyes, indolizine dyes, pyrylium dyes, quinoid dyes, quinone dyes, phthalocyanine dyes, naphthalocyanine dyes, azo dyes, hexafunctional polyester oligomers, heterocyclic compounds, and combinations thereof.

46. The medium, as in claim 45, wherein the polymethyl indolium compound is further comprised of at least one of the compounds chosen from the group consisting of:
2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate; 2-[2-[2-Chloro-3-[2-(1,3-dihydro-1,3,3-trimethyl-2H-indol-2-ylidene)ethylidene]-1-cyclopenten-1-yl-ethenyl]-1,3,3-trimethyl-3H-indolium chloride; 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene)ethylidene]-2-(phenylthio)-1-cyclohexen-1-yl]ethenyl]-3,3-dimethyl-1-propylindolium perchlorate; and mixtures thereof.

47. The medium, as in claim 45, wherein the polymethine dye compound is further comprised of:
pyrimidinetrione-clopentylidenes.

48. The medium, as in claim 45, wherein the squarylium dye is further comprised of:
a guaiazulenyl dye.

49. The medium, as in claim 39, wherein the antenna is further comprised of at least one of the compounds chosen from the group consisting of:
indocyanine dyes such as 3H-indolium,2-[5-(1,3-dihydro-3,3-dimethyl-1-propyl-2H-indol-2-ylidene)-1,3-pentadienyl]-3,3-dimethyl-1-propyl-,iodide) (Dye 724 λmax 642 nm), 3H-indolium, 1-butyl-2-[5-(1-butyl-1,3-dihydro-3,3-dimethyl-2H-indol-2-ylidene)-1,3-pentadienyl]-3,3-dimethyl-,perchlorate (Dye 683 λmax 642 nm), and phenoxazine derivatives such as phenoxazin-5-ium,3,7-bis(diethylamino)-,perchlorate (oxazine 1 λmax=645 nm) and mixtures thereof.

50. The medium, as in claim 39, wherein the antenna is further comprised of at least one of the compounds chosen from the group consisting of:
1-(2-chloro-5-sulfophenyl)-3-methyl-4-(4-sulfophenyl)azo-2-pyrazolin-5-one disodium salt (□max=400 nm); ethyl 7-diethylaminocoumarin-3-carboxylate (□max=418 nm); 3,3-diethylthiacyanine ethylsulfate (□max=424 nm); 3-allyl-5-(3-ethyl-4-methyl-2-thiazolinylidene) rhodanine (□max=430 nm) and mixtures thereof.

51. The medium, as in claim 44, wherein the aluminum quinoline complexes are further comprised of at least one of the group of:
tris(8-hydroxyquinolinato)aluminum (CAS 2085-33-8) and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 14101-38-0), bis-tetraethylammonium-bis(1,2-dicyano-dithiolto)zinc(II) (CAS 21312-70-9), 2-(4,5-dihydronaphtho[1,2-d]-1,3-dithiol-2-ylidene)-4,5-dihydro-naphtho[1,2-d]1,3-dithiole and mixtures thereof.

52. The medium, as in claim 44, wherein the antenna is further comprised of:
indocyanine green.

53. The medium, as in claim 40, wherein the activator is further comprised of at least one of the compounds chosen from the group consisting of:
zinc salts, carboxylates, phenolic compounds, or calcium salts, and combinations thereof.

54. The medium, as in claim 53, wherein the zinc salts are further comprised of:
zinc stearate, zinc hexanoate, zinc salicylate, or zinc acetate and mixtures thereof.

55. The medium, as in claim 53, wherein the phenolic compounds are further comprised of:
bisphenol-A.

56. The medium, as in claim 53, wherein the phenolic compounds are further comprised of:
TG-SA.

57. The medium, as in claim 53, wherein the activator is further comprised of:
sulfonyl diphenol.

58. The medium, as in claim 38, wherein the activator comprises by weight 5 to 40 weight % solid particles.

59. The medium, as in claim 58, wherein the activator comprises by weight 10 to 20 weight % solid particles.

60. The medium, as in claim 38, wherein the compound is further comprised of:
a matrix in which the color formers are dispersed.

61. The medium, as in claim 60, wherein the matrix is further comprised of:
UV-curable polymers.

62. The medium, as in claim 61, wherein the polymers are further comprised of at least one of the compounds chosen from the group consisting of:
acrylate derivatives, oligomers, monomers, and combinations thereof.

63. The medium, as in claim 62, wherein the polymers are further comprised of at least one of the compounds chosen from the group consisting of:
polyvinyl alcohol, polyvinyl chloride, polyvinyl butyral, cellulose esters and blends such as cellulose acetate butyrate, polymers of styrene, butadiene, ethylene, poly carbonates, polymers of vinyl carbonates, co-polymers of acrylic and allyl carbonate momoners, and combinations thereof.

64. The medium, as In claim 62, wherein the polymers are further comprised of at least one of the compounds chosen from the group consisting of:
acyloin compounds, aromatic diazonium salts, aromatic halonium salts, aromatic sulfonium salts, phosphine oxide, amine-ketne class, metallocene compounds, and combinations thereof.

65. The medium, as claim 60, wherein the matrix is further comprised of:
binders.

66. The medium, as claim 65, wherein the binders are comprised of at least one of the compounds chosen from the group consisting of;
polyacrylates, polyvinyl alcohols, polyvinyl pyrrolidines, polyethylenes, polyphenols or polyphenolic esters, polyurethanes, acrylic polymers, and mixtures thereof.

67. The medium, as claim 66, wherein the binders are comprised of at least one of the compounds chosen from the group consisting of:
cellulose acetate butyrate, ethyl acetate butyrate, polymethyl methacrylate, polyvinyl butyral, and mixtures thereof.

68. An imaging means, comprising:
a means for absorbing energy combined with a means for forming multiple colors; and
a means for initiating a plurality of color changes in the color forming means through a plurality of light exposures.

69. The imaging means, as in claim 68, wherein the energy absorbing means is further comprised of:
an antenna.

70. The imaging means, as in claim 69, wherein the antenna is further comprised of:
a radiation absorbing compound that readily absorbs the desired specific wavelength of the marking radiation.

71. The imaging means, as in claim 69, wherein the antenna is further comprised of at least one of the compounds chosen from the group consisting of:
aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures or derivatives thereof.

72. The imaging means, as in claim 70, wherein the antenna is further comprised of at least one of the compounds chosen from the group consisting of:
polymethyl Indoliums, metal complex IR dyes, indocyanine green, polymethine dyes, guaiazulenyl dyes, croconium dyes, cyanine dyes, squarylium dyes, chalcogenopyryloarylidene dyes, metal thiolate complex dyes, bis(chalcogenopyrylo)polymethine dyes, oxyindolizine dyes, bis(aminoaryl)polymethine dyes, indolizine dyes, pyrylium dyes, quinoid dyes, quinone dyes, phthalocyanine dyes, naphthalocyanine dyes, azo dyes, hexafunctional polyester oligomers, heterocyclic compounds, and combinations thereof.

73. The imaging means, as in claim 72, wherein the polymethyl indolium compound is further comprised of at least one of the compounds chosen from the group consisting of:
2-[2-[2-chloro-3-[2-(1,3-dihydro-1,3,3-trimethyl-2H-indol-2-ylidene)-ethylidene]-1-cyclopenten-1-yl-ethenyl-1,3,3-trimethyl-3H-indolium perchlorate; 2-[2-[2-Chloro-3-[2-(1,3-dihydro-1,3,3-trimethyl-2H-indol-2-ylidene)ethylidene]-1-cyclopenten-1-yl-ethenyl]-1,3,3-trimethyl-3H-indolium chloride; 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene)ethylidene]-2-(phenylthio)-1-cyclohexen-1-yl]ethenyl]-3,3-dimethyl-1-propylindolium perchlorate; and mixtures thereof.

74. The imaging means, as in claim 72, wherein the polymethine dye compound is further comprised of:
pyrimidinetrione-cyclopentylidenes.

75. The imaging means, as in claim 72, wherein the squarylium dye is further comprised of:
a guaiazulenyl dye.

76. The imaging means, as in claim 70, wherein the antenna is further comprised of at least one of the compounds chosen from the group consisting of:
indocyanine dyes such as 3H-indolium,2-[5-(1,3-dihydro-3,3-dimethyl-1-propyl-2H-indol-2-ylidene)-1,3-pentadienyl]-3,3-dimethyl-1-propyl-,iodide) (Dye 724 λmax 642 nm), 3H-indolium, 1-butyl-2-[5-(1-butyl-1,3-dihydro-3,3-dimethyl-2H-indol-2-ylidene-1,3-pentadienyl]-3,3-dimethyl-,perchlorate (Dye 683 λmax 642 nm), and phenoxazine derivatives such as phenoxazin-5-ium,3,7-bis(diethylamino)-,perchlorate (oxazine 1 λmax=645 nm) and mixtures thereof.

77. The imaging means, as in claim 70, wherein the antenna is further comprised of at least one of the compounds chosen from the group consisting of:
1-(2-chloro-sulfophenyl)₃-methyl-4-(4-sulfophenyl)azo-2-pyrazolin-5-one disodium salt (οmax=400 nm); ethyl 7-diethylaminocoumarin-3-carboxylate (□max=418 nm); 3,3′-diethylthiacyanine ethylsulfate (□max=424 nm); 3-allyl-5-(3-ethyl-4-methyl-2-thiazolinylidene) rhodanine (□max=430 nm) and mixtures thereof.

78. The imaging means, as in claim 71, wherein the aluminum quinoline complexes are further comprised of at least one of the group of:
tris(8-hydroxyquinolinato)aluminum (CAS 2085-33-8) and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)zinc(II) (CAS 21312-70-9), 2-(4,5-dihydronaphtho[1,2-d]-1,3-dithiol-2-ylidene)-4,5-dihydro-naphtho[1,2-d]1,3-dithiole and mixtures thereof.

79. The imaging means, as in claim 71, wherein the antenna is further comprised of:
indocyanine green.

80. The imaging means, as in claim 68, wherein the means for multiple colors is further comprised of:
a color former mixture of at least two color formers; and
at least one activator, wherein the color former reacts at a first light exposure to create a first color and the color former also reacts at a second light exposure to create a second color that is distinct from the first color.

81. The imaging means, as in claim 80, wherein the color former mixture is further comprised of:
leuco dyes.

82. The imaging means, as in claim 81, wherein the leuco dyes are further comprised of:
dyes in a form which is, prior to development, substantially colorless or white, and which changes color(s) upon exposure to light.

83. The imaging means, as In claim 81, wherein the leuco dyes are further comprised of:
a flouran leuco dye.

84. The imaging means, as in claim 80, wherein the activator Is further comprised of at least one of the compounds chosen from the group consisting of:
zinc salts, carboxylates, phenolic compounds, or calcium salts, and combinations thereof.

85. The imaging means, as in claim 84, wherein the zinc salts are further comprised of:
zinc stearate, zinc hexanoate, zinc salicylate, or zinc acetate and mixtures thereof.

86. The imaging means, as in claim 84, wherein the phenolic compounds are further comprised of:
bisphenol-A.

87. The imaging means, as in claim 84, wherein the phenolic compounds are further comprised of:
TG-SA.

88. The imaging means, as in claim 84, wherein the activator is further comprised of:
sulfonyl diphenol.

89. The imaging means, as in claim 80, wherein the activator comprises by weight 5 to 40 weight % solid particles.

90. The imaging means, as in claim 89, wherein the activator comprises by weight 10 to 20 weight % solid particles.

91. The imaging means, as in claim 80, wherein the color former mixture is further comprised of:
a matrix in which the color formers are dispersed.

92. The imaging means, as in claim 91, wherein the matrix is further comprised of:
UV-curable polymers.

93. The imaging means, as in claim 92, wherein the polymers are further comprised of at least one of the compounds chosen from the group consisting of:
acrylate derivatives, oligomers, monomers, and combinations thereof.

94. The imaging means, as in claim 93, wherein the polymers are further comprised of at least one of the compounds chosen from the group consisting of:
polyvinyl alcohol, polyvinyl chloride, polyvinyl butyral, cellulose esters and blends such as cellulose acetate butyrate, polymers of styrene, butadiene, ethylene, poly carbonates, polymers of vinyl carbonates, copolymers of acrylic and allyl carbonate momoners, and combinations thereof.

95. The imaging means, as in claim 93, wherein the polymers are further comprised of at least one of the compounds chosen from the group consisting of:
acyloin compounds, aromatic diazonium salts, aromatic halonium salts, aromatic sulfonium salts, phosphine oxide, amine-ketne class, metallocene compounds, and combinations thereof.

96. The imaging means, as claim 91, wherein the matrix is further comprised of:
binders.

97. The imaging means, as claim 96, wherein the binders are comprised of at least one of the compounds chosen from the group consisting of:
polyacrylates, polyvinyl alcohols, polyvinyl pyrrolidines, polyethylenes, polyphenols or polyphenolic esters, polyurethanes, acrylic polymers, and mixtures thereof.

98. The imaging means, as claim 97, wherein the binders are comprised of at least one of the compounds chosen from the group consisting of:
cellulose acetate butyrate, ethyl acetate butyrate, polymethyl methacrylate, polyvinyl butyral, and mixtures thereof.

99. The imaging means, as claim 68, wherein the means for initiating a plurality of color changes is further comprised of:
a laser.
